(19) United States
(12) Patent Application Publication
(10) Pub. No.: US 2014/0272823 A1
(43) Pub. Date: Sep. 18, 2014

(54) SYSTEMS AND METHODS FOR TEACHING PHONICS USING MOUTH POSITIONS STEPS

(71) Applicant: Phonics Mouth Positions + Plus, Los Angeles, CA (US)

(72) Inventor: Sukari N. Christian, Los Angeles, CA (US)

(21) Appl. No.: 13/831,672

(22) Filed: Mar. 15, 2013

(51) Int. Cl. G09B 19/04

(52) U.S. Cl. CPC G09B 19/04
USPC 434/169

(57) ABSTRACT

A computerized method for teaching phonics using series of mouth positions specifying placement of lips, teeth and tongue includes, but is not limited to any one or combination of: obtaining predefined mouth positions and keywords for a plurality of sounds; identifying a sound, setting initial mouth positions to a predefined state for the identified sound, thinking of a keyword associated with the identified sound, and vocalizing the identified sound with mouth positions set and while thinking the keyword.

### BACKGROUND

1. Field

The disclosure generally relates to systems and methods for facilitating learning of phonics sounds, and in particular embodiments, to systems and methods for learning English phonics sounds.

2. Background

Phonics is a method of teaching reading and pronunciation of words by teaching correlations between sounds and letters. Various online services and desktop software products provide information for learning how to read through phonics. This information may be presented as combinations of lessons, games, flashcards activities, worksheets, etc. For example, a lesson may instruct students regarding a sound that an individual letter makes, or a sound that a combination of letters makes (e.g., combination of letters “sh”).

Typically, an illustration of a single letter or a combination of letters is provided, along with an audio recording of correct pronunciation of the sound associated with the letter(s). Students can practice pronouncing the sound by re-playing the audio recording and repeating the played sound.

### SUMMARY

A computerized method for learning phonics includes, but is not limited to any one or combination of: providing a user interface displaying menu options associated with learning single letter sounds, receiving a selection of a menu option associated with learning pronunciation of a first single letter sound, and rendering a visualization of a series of mouth positions for pronouncing the first single letter sound.

In various embodiments, the visualization of the series of mouth positions includes any combination of instructions for lips placement, teeth placement, tongue placement, and keyword association.

In various embodiments, the visualization of the series of mouth positions includes a textual rendering of one or more steps.

In various embodiments, providing a video recording of an explanation of the mouth positions for pronouncing the first single letter sound.

In various embodiments, the method further includes providing an audio recording of an explanation of the mouth positions for pronouncing the first single letter sound.

In various embodiments, the user interface further displays menu options associated with learning pronunciation of a plurality of combinations of single letter consonant sounds and vowel sounds.

In various embodiments, the method further includes receiving a selection of a menu option associated with learning pronunciation of a combination of a first single letter consonant sound and a first vowel sound, and rendering a visualization of a series of mouth positions for pronouncing the combination of the combination of the first single letter consonant sound and the first vowel sound.

A non-transitory computer-readable medium includes instructions stored thereon, the instructions comprising instructions to provide a user interface displaying menu options associated with learning of single letter sounds, instructions to receive a selection of a menu option associated with learning pronunciation of a first single letter sound, instructions to render a visualization of a series of mouth positions for pronouncing the first single letter sound.

In various embodiments, the visualization of the series of mouth positions includes any combination of instructions for lips placement, teeth placement, tongue placement, and keyword association.

In various embodiments, the visualization of the series of mouth positions includes a textual rendering of one or more steps.

In various embodiments, the instructions further comprise instructions to provide a video recording of an explanation of the mouth positions for pronouncing the first single letter sound.

In various embodiments, the instructions further comprise instructions to provide an audio recording of an explanation of the mouth positions for pronouncing the first single letter sound. In various embodiments, the instructions further comprise instructions to provide an animated movie of the mouth positions for pronouncing single letter sound.

In various embodiments, the user interface further displays menu options associated with learning pronunciation of a plurality of combinations of single letter consonant sounds and vowel sounds.

In various embodiments, the instructions further comprise instructions to receive a selection of a menu option associated with learning pronunciation of a combination of a first single letter consonant sound and a first vowel sound, and instructions to render a visualization of a series of mouth positions for pronouncing the combination of the first single letter consonant sound and the first vowel sound.

A method includes, but is not limited to any one or combination of: obtaining predefined mouth positions and keywords for a plurality of sounds; identifying a sound, setting initial mouth positions to a predefined state for the identified sound, thinking of a keyword associated with the identified sound, and vocalizing the identified sound with mouth positions set and while thinking the keyword.

In various embodiments, the identified sound is a short “e” sound of a letter “e” in the English alphabet, and wherein the mouth positions include closing mouth and lips naturally, frowning like a crying baby, pulling bottom jaw back until neck muscles tighten, and wherein the keyword is word elephant.

In various embodiments, the identified sound is short “i” sound of a letter “i” in the English alphabet, and wherein the mouth positions include closing mouth and lips naturally, pulling corners of mouth straight back towards ears, pulling bottom jaw back until neck muscles tighten, and wherein the keyword is word “is”.

In various embodiments, the identified sound is short “o” sound of a letter “o” in the English alphabet, and wherein the mouth positions include closing mouth and lips naturally, pulling lips into a round mouth, pulling bottom jaw back until neck muscles tighten, and wherein the keyword is word “olive”.

In various embodiments, the identified sound is “f” sound of a letter “f” in the English alphabet, and wherein the mouth positions include closing front teeth gently, not tightening lips, and wherein the keyword is word “fun”.

In various embodiments, the identified sound is “r” sound of a letter “r” in the English alphabet, and wherein the mouth positions include closing front teeth firmly, tightening lips into a pucker, roaring like angry lion, and wherein the keyword is word “run”.

In various embodiments, the identified sound is hard “g” sound of a letter “g” in the English alphabet, and wherein the mouth positions include dropping a bottom jaw to open mouth two inches, pushing base of tongue up to top of mouth, forcing a burst of air against close throat, and wherein the keyword is word “gap”.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1A illustrates a block diagram of an example environment in which a phonics teaching system provides phonics learning information to users of user devices in accordance with an example embodiment;

FIG. 1B is a block diagram of a computer system in accordance with an example embodiment;

FIG. 2 is a flow diagram of an example process for teaching sounds;

FIG. 3 is a flow diagram of an example process for teaching the short “A” vowel sound in accordance with an example embodiment;

FIG. 4 is a flow diagram of an example process for teaching the short “E” vowel sound in accordance with an example embodiment;

FIG. 5 is a flow diagram of an example process for teaching the short “I” vowel sound in accordance with an example embodiment;

FIG. 6 is a flow diagram of an example process for teaching the short “O” vowel sound in accordance with an example embodiment;

FIG. 7 is a flow diagram of an example process for teaching the short “U” vowel sound in accordance with an example embodiment;

FIG. 8 is a flow diagram of an example process for teaching the consonant “S” sound in accordance with an example embodiment;

FIG. 9 is a flow diagram of an example process for teaching the consonant “M” sound in accordance with an example embodiment;

FIG. 10 is a flow diagram of an example process for teaching the consonant “F” sound in accordance with an example embodiment;

FIG. 11 is a flow diagram of an example process for teaching the consonant “R” sound in accordance with an example embodiment;

FIG. 12 is a flow diagram of an example process for teaching the consonant “N” sound in accordance with an example embodiment;

FIG. 13 is a flow diagram of an example process for teaching the consonant “G” (hard) sound in accordance with an example embodiment;

FIG. 14 is a flow diagram of an example process for teaching the consonant “G” (soft) sound in accordance with an example embodiment;

FIG. 15 is a flow diagram of an example process for teaching the consonant “B” sound in accordance with an example embodiment;

FIG. 16 is a flow diagram of an example process for teaching the consonant “T” sound in accordance with an example embodiment;

FIG. 17 is a flow diagram of an example process for teaching the consonant “P” sound in accordance with an example embodiment;

FIG. 18 is a flow diagram of an example process for teaching the consonant “D” sound in accordance with an example embodiment;

FIG. 19 is a flow diagram of an example process for teaching the consonant “C” (hard) sound in accordance with an example embodiment;

FIG. 20 is a flow diagram of an example process for teaching the consonant “C” (soft) sound in accordance with an example embodiment;

FIG. 21 is a flow diagram of an example process for teaching the consonant “K” sound in accordance with an example embodiment;

FIG. 22 is a flow diagram of an example process for teaching the consonant “H” sound in accordance with an example embodiment;

FIG. 23 is a flow diagram of an example process for teaching the consonant “L” sound in accordance with an example embodiment;

FIG. 24 is a flow diagram of an example process for teaching the consonant “J” sound in accordance with an example embodiment;

FIG. 25 is a flow diagram of an example process for teaching the consonant W sound in accordance with an example embodiment;

FIG. 26 is a flow diagram of an example process for teaching the consonant “V” sound in accordance with an example embodiment;

FIG. 27 is a flow diagram of an example process for teaching the consonant “Q” sound in accordance with an example embodiment;

FIG. 28 is a flow diagram of an example process for teaching the consonant “Y” sound in accordance with an example embodiment;

FIG. 29 is a flow diagram of an example process for teaching the consonant “Z in accordance with an example embodiment;

FIG. 30 is a flow diagram of an example process for teaching the consonant X (mid and ending) sound in accordance with an example embodiment

FIGS. 31-32 are illustrations of a grid of combinations of single letter consonants with single letter vowels;

FIG. 33 is a flow diagram of an example process for teaching single letter sounds;

FIGS. 34A-B are illustrations of mouth positions for pronouncing the consonant “F” sound;

FIG. 35 is an illustration of mouth positions for pronouncing the consonant “G” (hard) sound;

FIG. 36 is an illustration of mouth positions for pronouncing the consonant “R” sound;

FIG. 37 is an illustration of mouth positions for pronouncing the short “A” vowel sound; and

FIG. 38 is an illustration of mouth positions for pronouncing the consonant “M” sound.

Like reference numbers and designations in the various drawings indicate like elements.

### DETAILED DESCRIPTION OF ILLUSTRATIVE IMPLEMENTATIONS

Using a phonics teaching system, shown in FIG. 1, users can learn phonics by following a series of mouth positions provided for each sound. A series of mouth positions are provided for each letter sound in the English alphabet, as well as for various combinations of letters in the English alphabet, or other sounds. The series of mouth positions can be also provided for sounds in other languages and/or sounds (e.g., single letter sounds, multiple letter sounds, etc.) in other language alphabets.

Each mouth position may specify placement of the lips, teeth, the entire tongue or a portion of the tongue. In some embodiments, in addition to various mouth positions, a useful keyword can be provided, for each sound. The keyword starts with the letter sound being taught. For example, when teaching the consonant letter sound “M”, a keyword “Mike” can be provided. The user can be instructed to think of the specified keyword while attempting to properly pronounce the letter sound. Advantageously, the use of the mouth position steps and the keywords can cause English phonetic sounds to be spoken with greater accuracy, speed and retention.

The phonics teaching system can be used in various settings including an entire classroom of students, one-on-one tutoring, on a user device using a network. In some embodiments, the phonics teaching system utilizes any one or combination of the following for teaching proper pronunciation of letters: animations (e.g., an animated movie of the mouth positions for pronouncing single letter sounds or multiple letter sounds), a video component, a musical component, an auditory component, a speech-based component, and/or a text-based component.

Referring to FIG. 1A, an example system environment 100A for teaching phonics to users of user devices 104 according to one embodiment is illustrated. The system environment 100A advantageously enables users to read and correctly pronounce words by providing teaching information for each single letter sound (e.g., for each vowel sound, and for each consonant sound) and/or for various combinations of letter sounds. The teaching information can include a series of steps that identify specific mouth positions the user needs to make in order to correctly pronounce the sound. The teaching information can be presented to the user in a recorded audio and/or video. For example, a narrative of the mouth positions steps can be provided to the user. In addition, a recorded sound that the letter makes and/or one or more keywords (e.g., 3 keywords) that start with the letter sound being learned can be provided.

Using their user devices 104, users have access to various teaching information such as lessons for each sound. User devices 104 can be any suitable network communication device capable of communicating over an electronic communication network 102. The network 102 can include a local area network (e.g., using Ethernet computer networking technologies), a wide area network (WAN), a wireless network (e.g., using a Bluetooth wireless technology), the Internet, or a combination thereof.

User devices 104 are configured to communicate with, transmit data to, and/or, receive data from the phonics teaching system 106 over the network 102. For example, each user device 104 may include a mobile phone with processing and display features, a desktop computer, a laptop computer, an electronic smart tablet or the like, programmed or otherwise configured to perform the operations described herein. Each user device 104 includes a display device that is configured to display user-perceptible information to a user. Each user device 104 also includes one or more user input devices (such as, but not limited to, touch screen, buttons, knobs or the like) to allow a user to input information. Example user devices 104 include personal computers, mobile communication devices, and other devices that can send and receive data over the network 102. In some implementations, the user devices 104 may include a user application, such as a web browser, to facilitate the sending and receiving of data over the network 102.

Each user device 104 is configured to provide visual presentations of phonics teaching information including animation film/movie, graphics and/or video, as well as audio recordings. In some embodiments, the user can access the phonics teaching information by accessing a website provided by the phonics teaching system 106. In these embodiments, the website displays to the user lessons and other information for learning sounds of various letters as described herein.

In other embodiments, a desktop application is installed on the user device 104, which provides to the user phonics learning lessons and other related information. In these embodiments, the desktop application may store at least some teaching information on the user device 104, and/or obtain at least some teaching information from the phonics teaching system 106. In some embodiments, the desktop application may be downloaded from a webpage. In other embodiments, the user is provided with any combination of one or more CDs (e.g., dictation check/test CDs), one or more DVDs, a curriculum booklet in text-form or a software program form, an information booklet in text-form or a software program form, sessions forms and sample session forms in text or on a software program, and publications recorded on a CD or a software program. The above may be entirely implemented on a software program viewable on the user device 104.

The phonics teaching system 106 includes a processing electronics 108 and communication electronics 110 capable of communication over the network 102, such as a local area network (e.g., using Ethernet computer networking technologies), a wide area network (WAN), a wireless network (e.g., using a Bluetooth wireless technology), the Internet, or a combination thereof.

As shown in FIG. 1A, the phonics teaching system 106 includes a data storage 112. The data storage 112 can store phonics teaching information (e.g., lessons, games, quizzes, worksheets, tests, results, etc.). The phonics teaching information stored in the data storage 112 can include codified mouth position steps for the movements necessary to perform each specific mouth position for each single letter sound as well as combinations of letters sounds. The data storage 112 can store various information related to each individual user including user progress with the phonics teaching program. The data storage 112 can include one or more electronic storage devices capable of storing electronic data, such as, but not limited to, a computer hard drive, disk drive, tape drive, or other suitable data storage device.

The phonics teaching system 106 can process information requests received from the user devices 104 and transmit requested information back to the user devices 104. The phonics teaching system 106 can update the information stored in the data storage 112 upon receiving information of user progress (e.g., completed lessons information). The phonics teaching information stored in the data storage 112 can be updated by an administrator of the phonics teaching system 106 or an instructor using a website, a desktop application, or manually.

The phonics teaching system 106 can provide individualized curriculum to the users that is customized based on the user's familiarity with sounds. The phonics teachings system 106 can request users to take tests in order to ensure that various sounds are learned accurately.

FIG. 1B is a block diagram of a computer system or a computing device in accordance with an illustrative implementation. The computer system or computing device 100B can be used to implement user devices 104, and/or components of the phonics teaching system 106, etc.

The computing system 100B includes a bus 205 or other communication component for communicating information and a processor 210 or processing circuit coupled to the bus 205 for processing information. The computing system 100B can also include one or more processors 210 or processing circuits coupled to the bus for processing information. The computing system 100B also includes main memory 215, such as a random access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 100B may further include a read only memory (ROM) 210 or other static storage device coupled to the bus 205 for storing static information and instructions for the processor 210. A storage device 225, such as a solid state device, magnetic disk or optical disk, is coupled to the bus 205 for persistently storing information and instructions.

The computing system 100B may be coupled via the bus 205 to a display 235, such as a liquid crystal display, or active matrix display, for displaying information to a user. An input device 230, such as a keyboard including alphanumeric and other keys, may be coupled to the bus 205 for communicating information and command selections to the processor 210. In another implementation, the input device 230 has a touch screen display 235. The input device 230 can include a cursor control, such as a mouse, a trackball, or cursor direction keys, for communicating direction information and command selections to the processor 210 and for controlling cursor movement on the display 235.

According to various implementations, the processes described herein can be implemented by the computing system 100B in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 100B to perform the illustrative processes described herein. One or more processors in a multi-processing arrangement may also be employed to execute the instructions contained in main memory 215. In alternative implementations, hard-wired circuitry may be used in place of or in combination with software instructions to effect illustrative implementations. Thus, implementations are not limited to any specific combination of hardware circuitry and software.

FIG. 2 is a flow diagram of a process 200 for teaching sound pronunciation in accordance with an illustrative implementation. At step 242, predefined head/mouth positions and keywords for a plurality of sounds are obtained. In some embodiments, the user device 104 obtains the mouth positions and keyword for the various sounds, over the network 102, from the phonics teaching system 106. The mouth positions and keywords may be provided in the form of a list, library or other compilation of a plurality of sounds (for example, all or some of the possible sounds in a particular language, such as, but not limited to, English), where each sound is associated in the list, library or other compilation with one or more mouth positions (or sets of mouth positions) and one or more keywords. In particular embodiments, each sound is associated, on a one-to-one basis, with a mouth position (or set of mouth positions) and a keyword. The list, library or compilation may be generated in advance (for example, by a service entity, linguist or authorized person or entity) by describing mouth positions associated with each sound (for example, all or some of the possible sounds in a particular language, such as, but not limited to, English) and selecting an appropriate keyword for each sound. Mouth positions may be described in the list, library or other compilation in any suitable manner, including, but not limited to a set of written instructions that describe orientations of the mouth and head (such as, but not limited to, orientations of teeth, jaws, lips, throat, etc.), photographs or drawings of mouth orientations, video clips that show mouth orientations and a mouth moving into the desired orientations, audio instructions that describe mouth orientations, or combinations thereof. This list, library or other compilation of mouth positions and keywords for each sound in the plurality of sounds may be electronically stored in the electronic storage of the user device 104. In other embodiments, a user obtains the list, library or other compilation of the mouth positions and keywords electronically (for example, but not limited to, downloading from a network site, retrieving from a nontransient storage device such as a disk, harddisk, RSB device, or the like) or on a physical document (for example, but not limited to, a book, printed paper, or the like).

At step 244, a desired sound is identified. In some embodiments, information identifying the desired sound is received. In these embodiments, the information may be received from a user interface when a user selects a particular sound of interest to the user. For example, a user may select a particular sound from a menu or library stored by the phonic teaching system 106 and/or the user device 104, where the menu or library is displayed to the user or otherwise accessible to the user through the user device 104. In an example embodiment, a user may access a menu or library by selecting an icon or other operator on the user device 104, where the icon or operator causes the user device 104 to retrieve the menu or library from electronic storage and display the menu or library on a display device associated with the user device 104. In other embodiments, the desired sound is identified by a user (e.g., a teacher, or a student) on a chalk board, lesson sheet, printout, computer screen, or the like, and is communicated to the system 106 by any suitable input process. In other embodiments, the desired sound is identified by the phonics teaching system 106, for example, from input information including, but not limited to audio input, text input, video or photographic input, or combinations thereof. In yet other embodiments, the desired sound is identified by the phonics teaching system 106 as part of teaching routine that selects sounds according to a predefined program, a pseudorandom routine or the like. For example, the phonics teaching system 106 may have stored a library of sounds and corresponding mouth positions and keywords. In this example, the system 106 may identify the desired sound for teaching to the user.

At step 246, based on the mouth position (or set of mouth positions) associated with the selected desired sound, the user sets initial positions of the user's head and mouth (e.g., teeth, jaw, lips, throat, etc.) to a predefined state for the desired sound. The initial positions may involve the user manipulating their mouth, lips, teeth, bottom and/or top jaw, neck muscles, etc. For example, the initial head and mouth positions may require the user to close or open their mouth, close or open lips a certain distance, pulling jaws, etc. These initial positions of the head and mouth for the desired sound may be derived from experimentations with various possible mouth positions for correct pronunciation of the desired sound.

At step 248, based on the keyword associated with the sounds in the list, library, or other compilation, the user thinks of the keyword associated with the desired sound, while the user's mouth is set in the mouth position (or set of mouth positions) associated with the desired sound. In particular embodiments, the user receives instructions from the phonic teaching system 106, to think of the keyword associated with the desired sound while holding the initial head and mouth positions prescribed in step 246. The first letter(s) of the keyword may correspond to the desired sound. In some embodiments include more than one possible keyword that starts with the desired sound. In other embodiments, one and no more than one single keyword is defined for each sound. This keyword can be updated at a later point to another keyword, for example, if a better keyword for the sound or user is identified. For example, the keywords for various sounds can be stored in the data storage 112 of the phonics teaching system 106, in a data storage of the user device 104, or storage in another computing device. Thinking of the keyword, while holding the mouth positions, may focus the user's attention on the desired sound.

At step 250, the user vocalizes the sound with mouth positions set and while thinking of the keyword. A combination of holding the prescribed mouth positions and thinking of the keyword associated with the desired sound and vocalizing the sound may cause the user to improve pronunciation of the sound. The user may perform the steps 246, 248 and 250 multiple times in order to achieve correct pronunciation of the sound.

The process 200 described above can be used for any single letter sound or any combination of sounds. Any sound can be taught by having the user vocalize the sound while holding specified mouth positions and thinking of a specified keyword. This process can be used for teaching sounds in any language.

FIGS. 3-30 illustrate flow diagrams of steps identifying specific mouth positions for pronouncing letter sounds as applied to the English language. In particular, each flow diagram includes a series of mouth positions steps for sounds of single letters found in the English alphabet. These mouth positions steps can be presented to the user as visual presentations and/or audio instructions. For example, drawings of the mouth positions, animated film or clip, and/or text explaining each mouth positions step can be provided to the user. In this example, audio recordings of narratives of the mouth positions steps can also be provided to the user. Although specific mouth positions are specified in FIGS. 3-30, other mouth positions can be utilized for making the same letter sounds.

FIGS. 3-7 provide series of mouth positions for each of the vowels “A”, “E”, “I”, “O”, and “U”. FIG. 3 is a flow diagram of a process 300 for teaching pronunciation of the short vowel sound “A”. At step 302, the user is instructed to close mouth and lips naturally. At step 304, the user is instructed to smile, with mouth still closed, until eyes feel a little tight. At step 306, the user is instructed to pull bottom jaw back until neck muscles are a little tight, while continuing to smile. This will open mouth just the right amount. At step 308, the user is instructed to while holding this mouth position, think of keyword ‘At’ and say the sound that begins the keyword. By performing the steps 302-308, the user learns proper pronunciation of the short “A” vowel sound. The instructions provided to the user in steps 302-308 may include steps, drawings, animation, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device. FIG. 37 provides exemplary illustrations of the mouth positions for pronouncing the short vowel sound “A”.

FIG. 4 is a flow diagram of a process 400 for teaching pronunciation of the short vowel sound “E”. At step 402, the user is instructed to close mouth and lips naturally. At step 404, the user is instructed to frown like a crying baby or sad face, with mouth still closed. At step 406, the user is instructed to pull bottom jaw back until neck muscles are a little tight, while continuing to hold sad face. Then, user is instructed to allow mouth to open naturally. At step 408, the user is instructed to think of a keyword “elephant” while holding this sad face mouth position, and then say the sound that begins the keyword. The “A” sound that is found in such word as: bread, lead, instead, and thread is the same sound as the “E” sound and can be made by using the same mouth position steps. The instructions provided to the user in steps 402-408 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 5 is a flow diagram of a process 500 for teaching pronunciation of the short vowel sound “I”. At step 502, the user is instructed to close their mouth and lips naturally. At step 504, the user is instructed to pull the corners of the mouth straight back towards the ears with the mouth still closed. At step 506, the user is instructed to pull bottom jaw back until neck muscles are a little tight while continuing to keep corners of the mouth pulled straight back towards ears, and then, allow the mouth to open naturally. At step 508, the user is instructed to think of a keyword ‘is’ while holding this straight back mouth position, and then saying the sound that begins with the keyword. The instructions provided to the user in steps 502-508 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 6 is a flow diagram of a process 600 for teaching pronunciation of the short vowel sound “O”. At step 602, the user is instructed to close their mouth and lips naturally. At step 604, the user is instructed to make lips into a round/opera singer mouth. Inside of the mouth should be round enough for a small ball to fit inside of At step 606, the user is instructed to the pull bottom jaw back. until neck muscles are a little tight, while continuing to have a round mouth, which will open the mouth just the right amount. At step 608, the user is instructed to think of a keyword ‘olive’ while holding this round mouth position, and then say the sound that begins the keyword “olive”. The instructions provided to the user in steps 602-608 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 7 is a flow diagram of a process 700 for teaching pronunciation of the short vowel sound “U”. At step 702, the user is instructed to close their mouth and lips naturally. At step 704, the user is instructed to open their lips and mouth slightly, in a relaxed manner. At step 706, the user is instructed not to exert any muscle control or tightening of the mouth or lips while continuing to keep the mouth and lips in the relaxed manner. At step 708, the user is instructed to think of a keyword “up” while holding this relaxed mouth position, and then say the sound that begins with the keyword “up”. The instructions provided to the user in steps 702-708 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 8 is a flow diagram of a process 800 for teaching pronunciation of the consonant sound “S”. At step 802, the user is instructed to open lips about half an inch wide. At step 804, the user is instructed to close front teeth gently and evenly. At step 806, the user is instructed to cause the muscles on each mouth corner to contract backwards a very small amount while placing the tip of the tongue very near closed front teeth but not touching, immediately after closing the front teeth. At step 808, while holding this position, the user is instructed to think of a keyword “soft” and blow a gentle stream of air through the closed front teeth. The instructions provided to the user in steps 802-808 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 9 is a flow diagram of a process 900 for teaching pronunciation of the consonant sound “M”. At step 902, the user is instructed to let lips close naturally. At step 904, the user is instructed to not tighten or purse/pucker lips. At step 906, the user is instructed to think of a keyword “Mike”. At step 908, the user is instructed to say the sound that begins with the keyword “Mike” with the mouth still closed, and not to open lips. At step 910, the user is instructed that when this sound is done correctly, the user will experience a tickling and feeling of vibration at the inside of the closed lips. The instructions provided to the user in steps 902-908 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device. FIG. 38 provides exemplary illustrations of the mouth positions for pronouncing the consonant sound “F”.

FIG. 10 is a flow diagram of a process 1000 for teaching pronunciation of the consonant sound “F”. At step 1002, the user is instructed to close front teeth gently. At step 1004, the user is instructed to not tighten, purse, or pucker lips. At step 1006, the user is instructed to think of a keyword “fun”. At step 1008, the user is instructed to open the lips slightly, and then from this position, blow a steady gentle stream of air through the closed front teeth. The user is instructed that the lips may slightly touch the teeth. The instructions provided to the user in steps 1002-1008 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device. FIGS. 34A-B provide exemplary illustrations of the mouth positions for pronouncing the consonant sound “F”.

FIG. 11 is a flow diagram of a process 1100 for teaching pronunciation of the consonant sound “R”. At step 1102, the user is instructed to close front teeth firmly. At step 1104, the user is instructed to tighten their lips into a pucker. At step 1106, the user is instructed to think of a keyword “ran”. At step 1108, the user is instructed to roar like a very angry lion and say the sound that begins the keyword “ran”, while holding the mouth positions described in steps 1102 and 1104 and thinking of a keyword “ran”. The instructions provided to the user in steps 1102-1108 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device. FIG. 36 provides exemplary illustrations of the mouth positions for pronouncing the consonant sound “R”.

FIG. 12 is a flow diagram of a process 1200 for teaching pronunciation of the consonant sound “N”. At step 1202, the user is instructed to open their mouth about one inch. At step 1204, the user is instructed to place the tip of the tongue on the ridge of mouth at the base of the upper teeth. At step 1206, the user is instructed to think of a keyword “note”. At step 1208, the user is instructed to hum against the area where the tip of the tongue meets the ridge of the mouth. At step 1210, the user is instructed not to press too hard with the tongue and not to move the tongue from the ridge of the mouth. At step 1202, the user is instructed that they will feel a slight bit of vibration where the ridge of the mouth meets the tip of the tongue. The instructions provided to the user in steps 1202-1212 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 13 is a flow diagram of a process 1300 for teaching pronunciation of the “hard” consonant sound “G”. At step 1302, the user is instructed to drop the bottom jaw to open the mouth about two inches. At step 1304, the user is instructed to push base of tongue (i.e., the part right before the throat opening) up to the top of the mouth, cutting off the ability to breath. At step 1306, the user is instructed to think of a keyword “gap”. At step 1308, the user is instructed that while continue to think of the keyword “gap” say the sound that begins the keyword by forcing a burst of air against the closed throat. The user can be further instructed that this will force throat open to make the /G/ (hard) sound. At step 1310, the user is instructed not to lower the head as the user is doing this sound as this causes the air passage to be partially closed. At step 1312, the user is instructed that the only moving part in the mouth while doing this sound is the muscle at the top of the throat. The instructions provided to the user in steps 1302-1312 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device. FIG. 35 provides exemplary illustrations of the mouth positions for pronouncing the consonant sound “G”.

FIG. 14 is a flow diagram of a process 1400 for teaching pronunciation of the “soft” consonant sound “G”. At step 1402, the user is instructed to close side/jaw teeth firmly. At step 1404, the user is instructed to move the middle portion of the tongue up towards the roof of the mouth causing the sides of the tongue to firmly touch the insides of the upper middle teeth. At step 1406, the user is instructed to cause the top of the tongue directly after the middle portion to touch the roof of the mouth, but not the tip of the tongue. At step 1408, the user is instructed to think of a keyword “gym”, and without opening the teeth, to force a quick burst of air between the tongue and the roof of the mouth while saying the sound that begins the keyword “gym”. At step 1410, the user is instructed that this action will cause the tongue to be released from the roof of the mouth and make the /G/ (soft) sound. The instructions provided to the user in steps 1402-1410 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 15 is a flow diagram of a process 1500 for teaching pronunciation of the consonant sound “B”. At step 1502, the user is instructed to close front teeth lightly. At step 1504, the user is instructed to close lips naturally, and not to tighten or purse lips. The user is instruction to let the lips be natural. At step 1506, the user is instructed to think of a keyword “bog”, and while holding this position, to blow a steady stream of medium hard air through the closed teeth. At step 1508, the user is instructed that this action will rapidly open and close the lips to produce the sound that the letter ‘B” makes. At step 1510, the user is instructed that this sound is called the “baby blubber” sound, as a baby sometimes makes this sound. The instructions provided to the user in steps 1502-1510 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 16 is a flow diagram of a process 1600 for teaching pronunciation of the consonant sound “T”. At step 1602, the user is instructed to place the “flat tip” (i.e., the part of the tongue that is just below the tip) of the tongue on the ridge of the mouth at the top of the top teeth. At step 1604, the user is instructed that at the same time, the user needs to open the mouth, whose corners will pull backward just a little, naturally. At step 1606, the user is instructed to think of a keyword “tame”. At step 1608, the user is instructed to say the sound that begins the keyword “tame”, while thinking of the keyword “tame”, by causing a burst of air to strike the ‘flat tip’ of the tongue, dislodging the tongue from the ridge of the mouth at the top of the top teeth. The instructions provided to the user in steps 1602-1608 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 17 is a flow diagram of a process 1700 teaching pronunciation of the consonant sound “P”. At step 1702, the user is instructed to close lips naturally. At step 1704, the user is instructed not to close front teeth and to think of the keyword “pat”. At step 1706, the user is instructed to say the sound that begins the keyword “pat” by blowing a medium puff of air through the closed lips, while holding this position and thinking of the keyword “pat”. At step 1708, the user is instructed not to use any lip, tongue, or jaw muscles while blowing the puff of air. At step 1710, the user is instructed that the puff of air will cause lips to pop open and make the /P/ sound. The instructions provided to the user in steps 402-1710 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 18 is a flow diagram of a process 1800 for teaching pronunciation of the consonant sound “D”. At step 1802, the user is instructed to open lips and teeth just a little. At step 1804, the user is instructed to place the ‘flat’ tip of the tongue on the top of the mouth, very close to, but not touching, the top of the top teeth. At step 1806, the user is instructed to think of a keyword “dot”, while holding this position. At step 1808, the user is instructed to say the sound that begins the key word “dot”, by blowing a burst of air against the ‘flat’ tip of the tongue. At step 1810, the user is instructed that this burst of air will cause the tongue to leave the top of the mouth, making the /D/ sound. The instructions provided to the user in steps 1802-1810 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 19 is a flow diagram of a process 1900 for teaching pronunciation of the consonant sound “C”. At step 1902, the user is instructed to open the mouth about half an inch At step 1904, the user is instructed to close the air passage through the mouth by raising up the muscle located at the base of the tongue (directly before the throat opening) until it touches the roof of the mouth. At step 1906, the user is instructed to think of the keyword “cake”. At step 1908, the user is instructed to say the sound that begins the keyword “cake” by forcing a burst of air against the raised tongue muscle, causing it to open the air passage. The instructions provided to the user in steps 1902-1908 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 20 is a flow diagram of a process 2000 for teaching pronunciation of the “soft” consonant sound “C”. The soft consonant sound “C” is similar to the “/S/” sound. At step 100B2, the user is instructed to Open lips about V2 inch wide. At step 100B4, the user is instructed to close front teeth gently and evenly. At step 100B6, the user is instructed to, immediately after closing front teeth, cause the muscles on each mouth corner to be pulled backwards a very small amount while placing the tip of the tongue very near closed front teeth but not touching. At step 100B8, the user is instructed to think of the keyword “cent”. At step 2010, the user is instructed to make the C (soft) sound by blowing a gentle stream of air past tongue and through the closed front teeth, while thinking of the keyword “cent”. The instructions provided to the user in steps 2002-2010 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 21 is a flow diagram of a process 2100 for teaching pronunciation of the “soft” consonant sound “K”. The mouth positions for making this sound are the same as the mouth positions for pronouncing the “C” (hard) sound. At step 2102, the user is instructed to open mouth about half of an inch. At step 2104, the user is instructed to close the air passage through the mouth by raising up the muscle located at the base of the tongue (directly before the throat opening) until it touches the roof of the mouth. At step 2106, the user is instructed to think of the keyword “king”. At step 2108, the user is instructed to say the sound that begins the keyword “king” by forcing a burst of air against the raised tongue muscle, causing it to open the air passage. The instructions provided to the user in steps 2102-2108 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 22 is a flow diagram of a process 2200 for teaching pronunciation of the consonant sound “H”. At step 2202, the user is instructed to open the mouth and lips about three fourth of an inch wide. At step 2204, the user is instructed to think of the keyword “hat”. At step 2206, the user is instructed to say the sound that begins the keyword “hat” by forcing a quick huff of air out through an open mouth, while thinking of the keyword “hat”. This is the same action one would take on a cold morning to make frost on a window with the breath. The instructions provided to the user in steps 2202-2208 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 23 is a flow diagram of a process 2300 for teaching pronunciation of the consonant sound “L”. At step 2302, the user is instructed to open lips about half an inch wide. At step 2304, the user is instructed to place the tip of the tongue squarely on the ridge at the top of the mouth, next to top of the top teeth. At step 2306, the user is instructed to make the sound that begins the keyword “late” by humming directly onto the tip of the tongue. At step 2308, the user instructed to observe that when done correctly, the tongue will seem to become wider, but it will not move from the ridge of the upper mouth. The instructions provided to the user in steps 2302-2308 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 24 is a flow diagram of a process 2400 for teaching pronunciation of the consonant sound “J” which is similar to that of the soft “G” sound. At step 2402, the user is instructed to close their side/jaw teeth firmly. At step 2404, the user is instructed to move the middle portion of the tongue up towards the roof of the mouth causing the sides of the tongue to firmly touch the insides of the upper middle teeth. At step 2406, the user is instructed to cause the top of the tongue directly after the middle portion to touch the roof of the mouth, but not the tip of the tongue. At step 2408, the user is instructed to think of the keyword “jam”, and without opening the teeth, to force a quick burst of air between tongue and the roof of the mouth while saying the sound that begins the keyword. At step 2410, the user is instructed that this action will cause the tongue to be dislodged from the roof of the mouth and make the /J/ sound. The instructions provided to the user in steps 2402-2410 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 25 is a flow diagram of a process 2500 for teaching pronunciation of the consonant sound “W”. At step 2502, the user is instructed to pucker lip softly. At step 2504, the user is instructed to think of the keyword “win”. At step 2506, the user is instructed to blow a medium hard stream of air through the puckered lips to make the sound (the “haunting ghost” sound) that begins the keyword, while holding the mouth positions described in step 2502 position and thinking of the keyword “win”. The instructions provided to the user in steps 2502-2506 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 26 is a flow diagram of a process 2600 for teaching pronunciation of the consonant sound “W”. At step 2602, the user is instructed to close front teeth firmly. At step 2604, the user is instructed to tighten lips towards closed front teeth, but not to completely close lips. At step 2604, the user is instructed to place the tongue in front of the closed front teeth, but not too close. At step 2606, the user is instructed to think of the keyword “vote” and blow a gentle stream of air through the closed front teeth, while holding the mouth positions described in steps 2602, 2604, and 2606. At step 2608, the user is instructed that this stream of air will make the /V/ sound by causing the air to vibrate against the front teeth and lips. The instructions provided to the user in steps 2602-2608 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 27 is a flow diagram of a process 2700 for teaching pronunciation of the consonant sound “Qu”. At step 2702, the user is instructed to open lips into an O shape. At step 2704, the user is instructed to pull the tongue slightly back and down from the mouth opening, not touching the bottom of the mouth. At step 2706, the user is instructed to think of the keyword “quick”. At step 2708, the user is instructed to say the /K/ sound and then the /W/ sound, without changing the shape of the mouth, one right after the other, while holding the mouth positions described in steps 2702 and 2704 and thinking of the keyword “quick”. At step 2710, the user is instructed that this will sound like a gust of wind that the user might hear outside. The instructions provided to the user in steps 2702-2710 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 28 is a flow diagram of a process 2800 for teaching pronunciation of the consonant sound “Y”. At step 2802, the user is instructed to open lips about one fourth of an inch wide. At step 2804, the user is instructed to close the back teeth firmly. At step 2806, the user is instructed to push the base, near the throat opening, upward until both sides of the back of the tongue are touching both sides of the roof of the mouth near the back teeth, while keeping the back teeth firmly closed. This will leave an air passageway. At step 2808, the user is instructed to think of the keyword “yes”. At step 2810, the user is instructed to make the sound that begins the keyword “yes” by blowing a hard, steady stream of air through the closed back teeth and the air passage. At step 2812, the user is instructed that there will be a vibration in the teeth when this sound is done correctly. The instructions provided to the user in steps 2802-2812 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 29 is a flow diagram of a process 2900 for teaching pronunciation of the consonant sound “Z”. At step 2902, the user is instructed to close the front teeth firmly. At step 2904, the user is instructed to open the lips about a fourth of an inch wide, pulling the corners of the mouth backward a small amount. At step 2906, the user is instructed to place the tongue very close to the closed front teeth such that a small amount of the tongue may touch the teeth but the tip of tongue does not touch teeth. At step 2908, the user is instructed to think of the keyword “zip”. At step 2910, the user is instructed to blow a steady stream of air past the tongue and through the teeth, while holding the mouth positions described in steps 2902, 2904, and 2906 and thinking of the keyword “zip”. At step 2912, the user is instructed that the air blowing will cause vibration to the tongue and the front teeth. The instructions provided to the user in steps 2902-2912 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 30 is a flow diagram of a process 3000 for teaching pronunciation of the consonant sound “X” (i.e., the middle and ending sound). At step 3002, the user is instructed to open lips about ¾ inch wide. At step 3004, the user is instructed to make the /K/ sound using the mouth positions described in FIG. 21 and in the same breath, make the /S/ sound using the mouth positions described in FIG. 8. At step 3004, the user is instructed that the mouth needs to open on the /K/ sound and then the teeth need to closed to make the /S/ sound. At step 3004, the user is instructed to that this sound will be similar to the word ‘kiss’ but minus the short I sound. The user may be instructed that when the letter “X” appears in the beginning of the words like “xylophone”, then it is pronounced the same as the letter “Z”. At the same time, in a word like “x-ray”, the letter “X” is pronounced as “X”. The instructions provided to the user in steps 3002-3008 may include steps, drawings, and/or other visual representations, and audio and/or video. In some embodiments, these user instructions may be communicated from the phonics teaching system 106, over the network 102, to the user device 104. In other embodiments, an application running on the user device 104 obtains these user instructions from storage in the user device 104 or another computing device.

FIG. 31 provides an illustration of a grid 3100 of combinations of single letter consonants with single letter vowels. FIG. 32 provides a grid 3200 that is similar to the grid 3100 but also includes exemplary order in which the combinations of sounds may be taught. For example, as indicated, a combination of sounds “ba” may be learned first, and a combination of sounds “CE” may be learned second etc. A sound being taught (e.g., “ba” sound) may be vocalized (e.g., by a human or on a computing device) to the learner/teacher starting from the “ba” position in a diagonal pattern thereby avoiding the repetitious use of any consonant or vowel. An exemplary order of teaching sound combinations of a single consonant and a single vowel may be: ba, ce, di, fo, gu, ha, je, ki, lo, mu, na, pu, qui, ro, su, ta, ye, wi, xo, yu, za, be, ci, do, fu etc.

Using the user device 104, the grids 3100 and/or 3200 can be viewed by the user on a webpage associated with the phonics teaching system 106 or on a desktop application installed on the user device 104. As shown, all the consonants are displayed vertically on the left side of each grid, while all the vowels are displayed horizontally on the top of each grid. Each cell in the grid represents a combination of a single consonant letter together with a single vowel letter. For example, the first cell in the first column and the first row represents a combination of letters “BA”. The combination of letters is pronounced by simultaneously pronouncing the single letter consonant sound with the single letter vowel sound. In this example, the “B” sound is pronounced in accordance with instructions in FIG. 15 and the “A” sound is pronounced in accordance with instructions in FIG. 3.

The grids 3100 and 3200 may be used to improve the learner's or teacher's ability to hear and say the initial sound of words starting with a consonant and short vowel sound. In some embodiments, these grids may be used after all single letter sounds are mastered. The process of teaching single consonant and single vowel sound combination using the grids 3100 and 3200 may involve requesting that the user or student write down (e.g., type in the letters on a user interface or write the letters down on a piece of paper or workbook) the combination of the consonant and vowel combinations (e.g., “ba”, “ce”, “di”, etc) and/or pronouncing the consonant-vowel sound (e.g., ba says /ba/, ce say /ce/, or di says /di/).

In some embodiments, when teaching of the consonant-vowel sound is completed, a checkmark may be placed (e.g., in the computer user interface or by a teacher on a piece of paper) in the grid cell corresponding to the sound. If the student got the spelling wrong, the incorrect spelling may be placed in the corresponding cell in the grid. After the spelling and sound pronunciation are performed corrected, a check mark or another completion indicator may be placed in the corresponding cell in the grid 3100 and another sound in the grid is taught. The student may be instructed that if their pronunciation or spelling of the sound combination is incorrect, the learner/teacher will then be required to restudy the sound, drill the sound correctly either by writing, saying and sounding the combination correctly if it was said incorrectly or if the spelling was wrong, restudying the sound that was written wrong, then writing, saying, and sounding out one row of the correct sound. For example, the student may practice the sound as follows: “m says /m/, m says /m/, m says /m/” until a full row is done. In another example, the written letter row may look as follows: m m m m m m m m m m m m m m.

In some embodiments, the grids 3100 and 3200 can be displayed to a user on the user device 104 (e.g., on a web page associated with the phonics teaching system 106 or an application installed on the user device). In these embodiments, the user can select a grid space (e.g., by clicking on a particular cell in the grid) from the grid, and then receive a lesson for the selected sound combination. In other embodiments, the order of sounds that are taught from the grid is predetermined. For example, the grid 3200 provides exemplary order in which the sounds are taught.

All known vowels sounds can be coupled or combined with all known consonant sounds. As a result, the phonics teaching system 106 can teach how to pronounce combinations of vowels and consonant sounds. An example of a vowel/consonant sound is the “_at” sound in the word “hat”. The phonics teaching system 106 can instruct the user that the vowel sound can be said simultaneously with the consonant sound, while using the mouth positions indicated in the mouth position instructions associated with the single letter sounds.

FIG. 33 is a flow diagram of a process 3300 for teaching single letter sounds in accordance with an illustrative embodiment. The process 3300 can be implemented on a computing device. In one embodiment, the process 3300 is encoded on a computer-readable medium that contains instructions that, when executed by the computing device, cause the computing device to perform operations of the process 3300.

The process includes providing (3302) a user interface displaying menu options associated with learning single letter sounds. In some embodiments, the user interface provides a listing of letters the user can select from. This listing of letters may include letters that the user has not learned yet, or all the letters.

A selection of a menu option associated with learning the pronunciation of a first single letter sound is received (3304). A visualization of a series of mouth positions for pronouncing the first single letter sound is rendered (3306). In some embodiments, the visualization of the series of mouth positions can include pictures of each mouth position, and/or text description breaking down each mouth position step. In addition, one or more videos and/or audio recordings can be provided describing the mouth positions. The visualization of each mouth position can include any combination of instructions for lips placement, teeth placement, tongue placement, and keyword association. For example, a mouth position can instruct the user to open their mouth a certain amount. FIGS. 3-30 illustrate exemplary mouth positions for various single letter sounds found in the English alphabet. Mouth positions along with a keyword can be identified for any sound in any language.

FIGS. 34A-B are illustrations of a series of mouth positions for pronouncing the consonant “F” sound in accordance with an illustrative embodiment. A mouth position illustration 3402 displays that the front teeth are gently closed. As further shown in mouth position illustrations 3404 and 3406, the lips are not tightened. A mouth position illustration 3408 displays thinking of a keyword “fun”. Finally, the mouth positions illustration displays opening the lips slightly while keeping the front teeth closed, These visualizations of the series of mouth positions advantageously demonstrate to the user proper placement of lips and teeth for pronouncing the consonant “F” sound.

FIG. 35 displays an illustration 3500 of a series of mouth positions 3500 for pronouncing the consonant “G” (hard) sound in accordance with an illustrative embodiment. A mouth position illustration 3502 displays an initial mouth position having a closed mouth. An illustration 3504 further displays the placement of the tongue inside the mouth. In particular, the base of the tongue is pushed up to the top of the mouth. A mouth position illustration 3506 illustrates dropping the bottom jaw to open the mouth (e.g., about two inches) and thinking of a word “Gap”. As shown in a mouth position illustration 3508, while thinking the instructed keyword, the sound that begins the keyword is pronounced by forcing a burst of air through an open mouth.

FIG. 36 provides an illustration 3600 of a series of mouth positions for pronouncing the consonant “R” sound in accordance with an illustrative embodiment. According to a mouth positions illustrations 3602, the front teeth are closed firmly. Next, a mouth positions illustration 3604 displays that the lips are tightened into a pucker, and a keyword “Ran” is being thought of. A mouth positions illustration 3606 displays saying the sound that begins the keyword “ran”, while holding the mouth positions illustrated in the illustrations 3602 and 3604.

FIG. 37 is an illustration of mouth positions for pronouncing the short “A” vowel sound in accordance with an illustrative embodiment. A mouth positions illustration 3702 illustrates closing the mouth and lips naturally, and then smiling with the mouth still closed. A mouth positions illustration 3704 displays pulling bottom jaw back, while continuing to smile. A mouth positions illustration 3706 displays thinking of a keyword beginning with the letter “a” (e.g., “at”), and saying the sound that begins the keyword.

FIG. 38 is an illustration of mouth positions for pronouncing the consonant “M” sound. As shown in a mouth positions illustration 3802, lips are closed naturally, without tightening. A mouth positions illustrations 3804 and 3806 illustrate experiencing a tickling and feeling of vibration at the inside of the closed lips, while thinking of a keyword “Mike”, and saying the sound that begins with the keyword “Mike” with the mouth still closed.

Although an example computing system has been described in FIG. 2, implementations of the subject matter and the functional operations described in this specification can be implemented in other types of digital electronic circuitry, or in computer software embodied on a tangible medium, firmware, or hardware, including the structures disclosed in this specification and their structural equivalents, or in combinations of one or more of them.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, but not limited to, a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A computerized method for learning phonics, the method comprising:
providing a user interface displaying menu options associated with learning single letter sounds;
receiving a selection of a menu option associated with learning pronunciation of a first single letter sound; and
rendering a visualization of a series of mouth positions for pronouncing the first single letter sound.

2. The method of claim 1, wherein the visualization of the series of mouth positions includes any combination of instructions for lips placement, teeth placement, tongue placement, and keyword association.

3. The method of claim 1, wherein the visualization of the series of mouth positions includes a textual rendering of one or more steps.

4. The method of claim 1, further comprising
providing a video recording of an explanation of the mouth positions for pronouncing the first single letter sound.

5. The method of claim 1, further comprising
providing an audio recording of an explanation of the mouth positions for pronouncing the first single letter sound.

6. The method of claim 1, wherein the user interface further displays menu options associated with learning pronunciation of a plurality of combinations of single letter consonant sounds and vowel sounds.

7. The method of claim 5, further comprising
receiving a selection of a menu option associated with learning pronunciation of a combination of a first single letter consonant sound and a first vowel sound;
rendering a visualization of a series of mouth positions for pronouncing the combination of the combination of the first single letter consonant sound and the first vowel sound.

8. A non-transitory computer-readable medium having instructions stored thereon, the instructions comprising:
instructions to provide a user interface displaying menu options associated with learning of single letter sounds;
instructions to receive a selection of a menu option associated with learning pronunciation of a first single letter sound; and
instructions to render a visualization of a series of mouth positions for pronouncing the first single letter sound.

9. The non-transitory computer-readable medium of claim 8, wherein the visualization of the series of mouth positions includes any combination of instructions for lips placement, teeth placement, tongue placement, and keyword association.

10. The non-transitory computer-readable medium of claim 8, wherein the visualization of the series of mouth positions includes a textual rendering of one or more steps.

11. The non-transitory computer-readable medium of claim 8, wherein the instructions further comprise
instructions to provide a video recording of an explanation of the mouth positions for pronouncing the first single letter sound.

12. The non-transitory computer-readable medium of claim 8, wherein the instructions further comprise
instructions to provide an audio recording of an explanation of the mouth positions for pronouncing the first single letter sound.

13. The non-transitory computer-readable medium of claim 12, wherein the user interface further displays menu options associated with learning pronunciation of a plurality of combinations of single letter consonant sounds and vowel sounds.

14. The non-transitory computer-readable medium of claim 13, wherein the instructions further comprise
instructions to receive a selection of a menu option associated with learning pronunciation of a combination of a first single letter consonant sound and a first vowel sound; and
instructions to render a visualization of a series of mouth positions for pronouncing the combination of the first single letter consonant sound and the first vowel sound.

15. A method comprising:
obtaining predefined mouth positions and keywords for a plurality of sounds;
identifying a sound;
setting initial mouth positions to a predefined state for the identified sound;
thinking of a keyword associated with the identified sound; and
vocalizing the identified sound with mouth positions set and while thinking the keyword.

16. The method of claim 15, wherein the identified sound is a short “e” sound of a letter “e” in the English alphabet, and wherein the mouth positions include closing mouth and lips naturally, frowning like a crying baby, pulling bottom jaw back until neck muscles tighten, and wherein the keyword is word elephant.

17. The method of claim 15, wherein the identified sound is short “i” sound of a letter “i” in the English alphabet, and wherein the mouth positions include closing mouth and lips naturally, pulling corners of mouth straight back towards ears, pulling bottom jaw back until neck muscles tighten, and wherein the keyword is word “is”.

18. The method of claim 15, wherein the identified sound is short “o” sound of a letter “o” in the English alphabet, and wherein the mouth positions include closing mouth and lips naturally, pulling lips into a round mouth, pulling bottom jaw back until neck muscles tighten, and wherein the keyword is word “olive”.

19. The method of claim 15, wherein the identified sound is “f” sound of a letter “f” in the English alphabet, and wherein the mouth positions include closing front teeth gently, not tightening lips, and wherein the keyword is word “fun”.

20. The method of claim 15, wherein the identified sound is “r” sound of a letter “r” in the English alphabet, and wherein the mouth positions include closing front teeth firmly, tightening lips into a pucker, roaring like angry lion, and wherein the keyword is word “run”.

21. The method of claim 15, the identified sound is hard “g” sound of a letter “g” in the English alphabet, and wherein the mouth positions include dropping a bottom jaw to open mouth two inches, pushing base of tongue up to top of mouth, forcing a burst of air against close throat, and wherein the keyword is word “gap”.
